(19) United States
(12) Patent Application Publication
(10) Pub. No.: US 2024/0094385 A1
(43) Pub. Date: Mar. 21, 2024

(54) ACOUSTIC OBSTACLE DETECTION WITH ENHANCED RESISTANCE TO SYSTEMATIC INTERFERENCE

(71) Applicant: SEMICONDUCTOR COMPONENTS INDUSTRIES, LLC, Scottsdale, AZ (US)

(72) Inventors: Marek HUSTAVA, Bratislava (SK); Pavel KOSTELNIK, Bordovice (CZ)

(73) Assignee: SEMICONDUCTOR COMPONENTS INDUSTRIES, LLC, Scottsdale, AZ (US)

(21) Appl. No.: 18/523,726

(22) Filed: Nov. 29, 2023

Related U.S. Application Data
(63) Continuation of application No. 17/479,557, filed on Sep. 20, 2021.
(60) Provisional application No. 63/124,266, filed on Dec. 11, 2020.

(51) Int. Cl. G01S 15/10; G01S 7/524; G01S 7/527

(52) U.S. Cl. CPC G01S 15/10; G01S 7/524; G01S 7/527; G01S 15/931

(57) ABSTRACT

An illustrative controller includes: a transmitter to drive the acoustic transducer to generate a series of acoustic bursts; a receiver coupled to the acoustic transducer to sense a response for each acoustic burst in the series; and a processing circuit to derive output data from said responses in part by determining a difference between one of the responses and at least a portion of another one of the responses. Another illustrative controller includes: a transmitter to drive the acoustic transducer to generate a series of acoustic bursts with signature sequence of frequency displacements; a receiver coupled to the acoustic transducer to sense a response for each acoustic burst in the series; and a processing circuit to derive output data from said responses in part by suppressing any peaks not conforming to the signature sequence.

### CROSS-REFERENCE TO RELATED APPLICATIONS

The present application is a continuation of U.S. patent application Ser. No. 17/479,557, filed on Sep. 20, 2021, which itself claims priority to U.S. Provisional Application No. 63/124,266, titled “Ultrasonic Sensor System” and filed 2020 Dec. 11, naming inventors Marek Hustava and Pavel Kostelnik. The foregoing applications are hereby incorporated herein by reference in their entireties.

### BACKGROUND

Modern automobiles are equipped with an impressive number and variety of sensors. For example, cars are now routinely equipped with arrays of ultrasonic sensors to monitor distances between the car and any nearby persons, pets, vehicles, or obstacles. Due to environmental “noise” and safety concerns, each of the sensors may be asked to provide tens of measurements each second while the car is in motion. It is important for such sensor arrays to perform reliably, even in environments that change in complex ways. Seemingly small differences, such as the presence or absence of a curb, or even the difference between paved and gravel surfaces, can significantly change the characteristic reflection of a pole, bollard, or other slim obstacle.

When the noise encountered by such sensors takes the form of systematic interference, i.e., noise that has a repetitive component which can recur in each measurement cycle, it can give rise to false obstacle detections or obscuration of actual obstacles. Examples include pneumatic noise such as vibrations originating from other cars (such as trucks) in the environment; ultrasound pulses originating from other ultrasonic sensors such as park-assist sensors of other cars, parking lot occupation detectors, and traffic light control systems; and crosstalk from other sensors or measurement channels. Existing sensors do not appear to provide sufficient immunity to such systematic interference.

### SUMMARY

Accordingly, there are disclosed herein illustrative sensor controllers, sensors, sensing systems, and sensing methods that at least partly address the issues identified above. As one example, an illustrative controller includes: a transmitter to drive the acoustic transducer to generate a series of acoustic bursts; a receiver coupled to the acoustic transducer to sense a response for each acoustic burst in the series; and a processing circuit to derive output data from said responses in part by determining a difference between one of the responses and at least a portion of another one of the responses.

As another example, an illustrative obstacle detection method includes: sensing an acoustic transducer's response to each acoustic burst in a series of acoustic bursts; determining a difference between one of the responses and at least a portion of another one of the responses; and detecting peaks in the difference at delays corresponding to distances of obstacles reflecting the acoustic bursts.

As yet another example, an illustrative controller includes: a transmitter to drive the acoustic transducer to generate a series of acoustic bursts with signature sequence of frequency displacements; a receiver coupled to the acoustic transducer to sense a response for each acoustic burst in the series; and a processing circuit to derive output data from said responses in part by suppressing any peaks not conforming to the signature sequence.

As still another example, an illustrative obstacle detection method includes: sensing an acoustic transducer's response to each acoustic burst in a series of acoustic bursts having a signature sequence of frequency displacements; combining the responses to obtain a combined response that enhances any peaks conforming to the signature sequence; and detecting peaks in the combined response at delays corresponding to distances of obstacles reflecting the acoustic bursts.

Each of the foregoing examples can be employed individually or in conjunction, and may include one or more of the following features in any suitable combination: 1. said one of the responses and said another one of the responses are responses to adjacent acoustic bursts of said series. 2. said one of the responses and said another one of the responses are responses to acoustic bursts of said series separated by a predetermined number of intervening acoustic bursts. 3. said another one of the responses is an intermittently determined baseline response. 4. said at least a portion includes a structural noise region. 5. the output data includes any detected peaks in a difference region of a combined response and any detected peaks in a subsequent correlation region of the combined response. 6. the series of acoustic bursts have a signature sequence of frequency displacements. 7. the processing circuit is configured to suppress any peaks in the difference response not conforming to the signature sequence. 8. the acoustic bursts of said series comprise chirps. 9. the frequency displacements cause corresponding time shifts of peaks in said responses. 10. the processing circuit is configured to derive a combined signal by time shifting responses to compensate for time shifts corresponding to the signature sequence. 11. the output data is derived by performing peak detection processing on the combined signal. 12. subtracting structural noise from the responses before said combining.

### BRIEF DESCRIPTION OF THE DRAWINGS

FIG. 1 is an overhead view of an illustrative vehicle equipped with ultrasonic sensors.

FIG. 2 is a block diagram of an illustrative parking assist system.

FIG. 3 is a circuit schematic of an illustrative acoustic obstacle sensor.

FIG. 4 is a schematic diagram illustrating one potential source of systematic interference.

FIG. 5 is a graph in which signal strength of a received and digitized signal is shown as a function of reception time, which graph indicates the presence of structural noise.

FIG. 6 is a block diagram of an illustrative sensor controller.

FIG. 7 is a graph comparing illustrative measurement cycles with three different frequency displacements.

FIG. 8 is a flow diagram of a first illustrative sensing method that enhances resistance to systematic interference with derivation processing.

FIG. 9 is a flow diagram of a second illustrative sensing method that enhances resistance using a signature sequence of frequency displacements.

### DETAILED DESCRIPTION

It should be understood that the drawings and following description do not limit the disclosure, but on the contrary, they provide the foundation for one of ordinary skill in the art to understand all modifications, equivalents, and alternatives falling within the scope of the claim language.

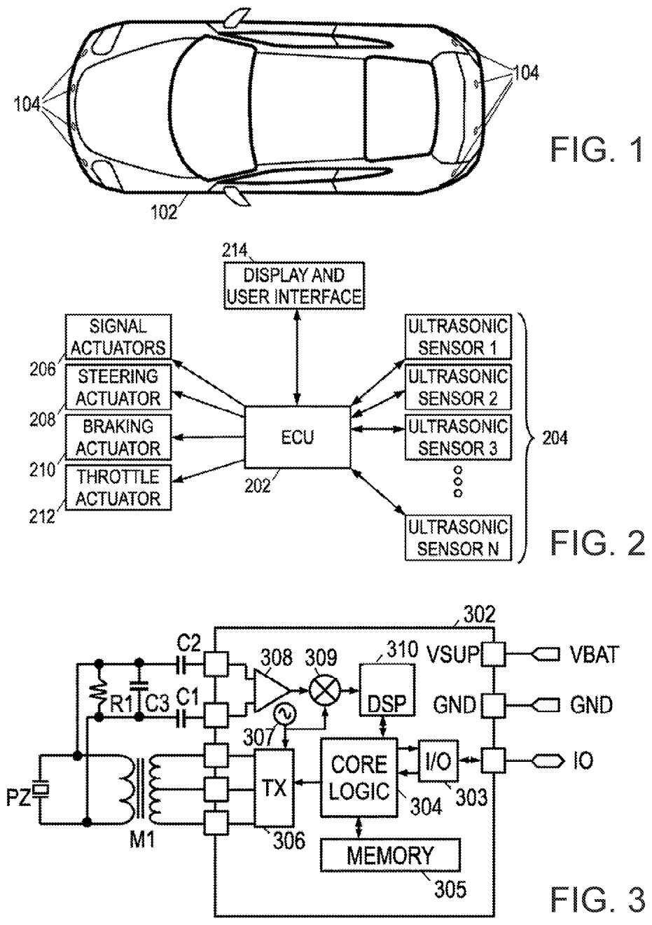

As an illustrative usage context, FIG. 1 shows a vehicle 102 equipped with a set of ultrasonic parking-assist sensors 104. The number and configuration of sensors in the sensor arrangement varies, and it would not be unusual to have six sensors on each bumper with two additional sensors on each side for blind-spot detectors. The vehicle may employ the sensor arrangement for detecting and measuring distances to objects in the various detection zones, potentially using the sensors for individual measurements as well as cooperative (e.g., triangulation, multi-receiver) measurements.

The ultrasonic sensors are transceivers, meaning that each sensor can transmit and receive bursts of ultrasonic sound. Emitted bursts propagate outward from the vehicle until they encounter and reflect from an object or some other form of acoustic impedance mismatch. The reflected bursts return to the vehicle as “echoes” of the emitted bursts. The times between the emitted bursts and received echoes are indicative of the distances to the reflection points. In many systems, only one sensor transmits at a time, though all of the sensors may be configured to measure the resulting echoes. However multiple simultaneous transmissions can be supported through the use of orthogonal waveforms, transmissions to non-overlapping detection zones, or transmissions with signatures that enable screening of any echoes from different transmitters.

In various implementations, use is made of chirp-modulated signals, for instance a linear frequency modulated (“LFM”) chirp. A chirp is a pulse that changes frequency during transmission. An up-chirp is a signal pulse that increases in frequency during transmission, and a down-chirp is a signal pulse that decreases in frequency during transmission. For clarity, the examples used herein will consider a linear increase or decrease, however in various implementations the increase or decrease is not linear. The echo of a chirp may be compressed in a correlator without introducing much or any correlation noise. As such, peak detection of the echo is eased without decreasing time resolution. Additionally, LFM chirps withstand Doppler frequency shift without, or with a minimum of, any increase in correlation noise. LFM chirps can be used as transmit pulses for measuring a distance to an obstacle, or object, situated in the sensing range of a sensor system.

For sake of clarity, the term “burst” as used herein refers to a single carrier-modulated (fixed frequency) or chirp-modulated (swept frequency) pulse, which may be one of a series of bursts created by driving an ultrasonic sensor or other acoustic transducer. Chirp-modulated pulses may have a longer duration than a typical carrier-modulated pulse, for instance more than 1 millisecond, such as in the range of 2-3 milliseconds. Although it is deemed particularly useful to systematically vary the starting frequency (or, equivalently, the center or ending frequency) of the chirp-modulated pulses in a series, such frequency variation can also be applied to the carrier-modulated pulses in a series. The frequency variation can be expressed for each pulse as a frequency displacement from a nominal starting frequency or from a nominal carrier frequency.

FIG. 2 shows an electronic control unit (ECU) 202 coupled to the various ultrasonic sensors 204 as the center of a star topology. Of course, other topologies including serial, parallel, and hierarchical (tree) topologies, are also suitable and contemplated for use in accordance with the principles disclosed herein. To provide automated parking assistance, the ECU 202 may further connect to a set of actuators such as a turn-signal actuator 206, a steering actuator 208, a braking actuator 210, and throttle actuator 212. ECU 202 may further couple to a user-interactive interface 214 to accept user input and provide a display of the various measurements and system status. Using the interface, sensors, and actuators, ECU 202 may provide automated parking, assisted parking, lane-change assistance, obstacle and blind-spot detection, and other desirable features.

One potential sensor configuration is now described with reference to FIG. 3. The illustrated sensor configuration employs the DSI3 communication and power supply standard, but other techniques such as those provided in the LIN, CAN, and SENT standards would also be suitable and are contemplated for use in accordance with the principles disclosed herein. Besides the two power terminals (Vbat and GND) shown in the implementation of FIG. 3, each of the illustrative ultrasonic sensors is only connected to the ECU 202 by a single input/output (“I/O” or “IO”) line. The I/O line may be biased to the supply voltage (the “de-asserted” state) by a pull-up resistor when it is not actively driven low (the “asserted” state) by the ECU 202 or by the sensor controller 302. The communication protocol is designed to have only one of the two controllers (ECU 202 or sensor controller 302) asserting the I/O line at any given time.

The sensor controller 302 includes an I/O interface 303 that, when placed in a recessive mode, monitors the I/O line for assertion by the ECU 202 and, when placed in a dominant mode, drives the state of the I/O line. The ECU communicates a command to the sensor by asserting the I/O line, the different commands being represented by assertions of different lengths. The commands may include a “send and receive” command, a “receive only” command, and a “data mode” command.

The sensor controller 302 includes a core logic 304 that operates in accordance with firmware and parameters stored in nonvolatile memory 305 to parse commands from the ECU and carry out the appropriate operations, including the transmission and reception of ultrasonic bursts. To transmit an ultrasonic burst, the core logic 304 is coupled to a transmitter 306 which, with a suitably modulated local oscillator signal from a voltage controlled oscillator 307, drives a set of transmit terminals on the sensor controller 302. The transmitter terminals are coupled via a transformer M1 to a piezoelectric element PZ. The transformer M1 steps up the voltage from the sensor controller (e.g., 12 volts) to a suitable level for driving the piezoelectric element (e.g., tens of volts). The piezoelectric element PZ has a resonance frequency that is tuned to a desirable value (e.g., 48 kHz) with a parallel capacitor C3, and has a resonance quality factor (Q) that is tuned with a parallel resistor R1. One illustrative purpose of the tuning capacitor and tuning resistor is to tune the parallel resonance frequency close to the series resonant frequency of the piezoelectric element.

As used herein, the term “piezoelectric transducer” includes not only the piezoelectric element, but also the supporting circuit elements for tuning, driving, and sensing, the piezoelectric element. In the illustrative implementation, these supporting elements are the transformer M1, the tuning resistor and tuning capacitor, and the DC-isolation capacitors. Optionally, output and input capacitance of the transmitter 306 and amplifier 308, respectively, may also be included as parasitic characteristics of the supporting circuit elements considered to be part of the transducer. However, the use of the term “piezoelectric transducer” does not necessarily require the presence of any supporting circuit elements, as a piezoelectric element may be employed alone without such supporting elements. In the illustrated implementation, a pair of DC-isolation capacitors C1, C2 couple the piezoelectric element to the sensor controller's pair of receive terminals to protect against high voltages. Further protection is provided with internal voltage clamps on the receive terminals. Such protection may be desired for the intervals when the piezoelectric element is transmitting.

Commands received via the I/O line trigger the core logic 304 to operate the transmitter and receiver and to provide the measurement results to the ECU 202 via the I/O line, also referred herein as a communication bus. The measurement results are herein also referred to as output data. The core logic 304 may monitor other sensor conditions such as having the supply voltage “under-voltage” or “over-voltage” while transmitting an ultrasonic burst, thermal shutdown of transmitter, a hardware error, an incomplete power-on reset, or the like. The core logic 304 may detect and classify multiple such transducer fault states and error conditions, storing the appropriate fault codes in internal registers or nonvolatile memory 305.

As the received echo signals are typically in the millivolt or microvolt range, a low-noise amplifier 308 (also referred to herein as a “front-end amplifier”) amplifies the signal from the receive terminals. Subsequently, the received echo signals are processed by an analog-to-digital converter (ADC) and downconverted by a digital mixer 309. Mixer 309 multiplies the amplified and digitized receive signal with the local oscillator signal to down convert the modulated signal to baseband, for further filtering and processing by a digital signal processor (DSP) 310. The mixer 309 is in one implementation an in-phase/quadrature (I/O) digital mixer 303, giving Zero Intermediate Frequency (ZIF) IQ data as its output. (Though the term “ZIF” is used herein, the downconverted signal may in practice be a low intermediate frequency or “near-baseband” signal.)

DSP 310 applies programmable methods to monitor the piezoelectric transducer during the transmission of a burst, and to detect any echoes and measure their parameters such as time-of-flight (ToF), duration, and peak amplitude. Such methods may employ threshold comparisons, minimum intervals, peak detections, zero-crossing detection and counting, noise level determinations, and other customizable techniques tailored for improving reliability and accuracy. Notably, the peak detection process itself has variations, with some variations performing rising edge detection, falling edge detection, or detection of the peak maximum. The DSP 310 may further process the amplified receive signal to analyze characteristics of the transducer, such as resonance frequency and quality factor, and may further detect transducer fault states.

As mentioned above, the mixer 309 is in one implementation a quadrature mixer. This I/O digital mixer 309 has an input connected to the output of an analog-to-digital converter (not shown), an input for receiving a mixing signal F_{TX}, and first and second outputs for providing an in-phase signal and a quadrature signal, respectively, that corresponds to an amplitude and a phase of the signal input from the acoustic transducer in the complex plane. The DSP may include one or more digital filters that are configured to retrieve and use filter coefficients stored in memory for operating on the ZIF-IQ signal. More particularly, the digital filters may include low-pass filters and correlators. The DSP may include programmable modules or dedicated circuitry for other operations, including phase derivation, magnitude measurement, down sampling, amplitude scaling (attenuation control), noise suppression, peak detection, reverberation monitoring, and transducer diagnostics, and an interface for host communications. Before discussing these modules further, certain types of systematic interference are first described.

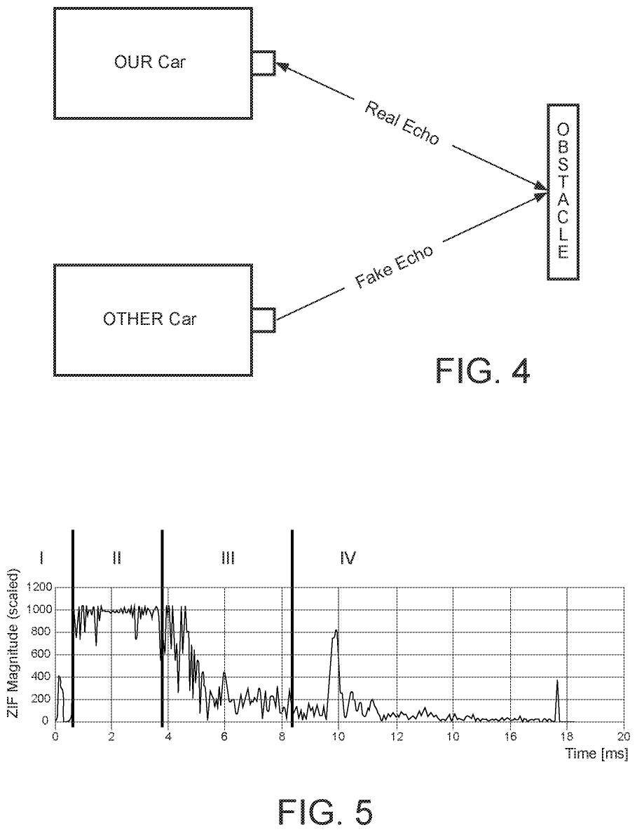

Echo measurements that are repeatable indicate the actual presence of reflectors, as opposed to random noise which for a given measurement might emulate a reflector but disappears from subsequent measurements. Systematic noise, however, can appear in each measurement, potentially indicating the presence of a nonexistent reflector or potentially masking the presence of an actual reflector. FIG. 4 shows one potential example, in which two ultrasonic sensing systems, each using similar frequencies and measurement cycles, are operating in close proximity. During a parking operation, a first car (“Our Car”) emits acoustic bursts and monitors for real echoes from an obstacle. The signals received by the first car may include acoustic bursts or associated echoes (“fake echoes”) from a second car (“Other Car”) also performing a parking operation. In the absence of any precautions, the false echoes are likely to be interpreted by Our Car as indicative of additional nearby obstacles in motion.

As another example, FIG. 5 is a graph in which the signal strength is set out as a function of the time of reception, for an ultrasonic sensor “hidden” behind a chassis panel to which it is coupled. The illustrated measurement cycle includes four periods: period I is a pre-transmission noise monitoring period, period II is a transmission and reverberation period, period III is a short-range measurement period, and period IV is a longer-range measurement period. During period I, the amplifier gain is maximized to enable a measurement of environmental noise levels. During period II, the ultrasonic sensor is driven to generate an acoustic burst, which is followed by a short reverberation. During period III, vibrations within the chassis panel produce structural noise, potentially masking any echoes from nearby reflectors. Thereafter, during period IV, echoes from more distant reflectors can be detected. Note that the reverberation and structural noise are essentially identical for adjacent bursts in the series of acoustic bursts, varying only slowly with temperature, accumulation of layers on the panel, and aging of the sensor components.

Other potential sources of systematic interference include crosstalk from other transducers or measurement channels, electrical noise, pneumatic noise or other acoustic noise with a periodic component, and processing noise. One example of processing noise may include autocorrelation noise arising from suboptimal filter design.

Two techniques disclosed herein combat systematic noise: derivation processing, and shifting frequencies in a signature sequence. Derivation processing involves calculating the difference between different measurements (such as measurements from acoustic bursts that are adjacent in the series), thereby removing systematic interference such as structural noise. Frequency shifting involves applying frequency displacements to acoustic bursts in the series in accordance with a signature sequence that is reasonably unique to the sensor, thereby enabling the sensor to distinguish echoes of its bursts from bursts or echoes from a different system. The two techniques are usable separately and together.

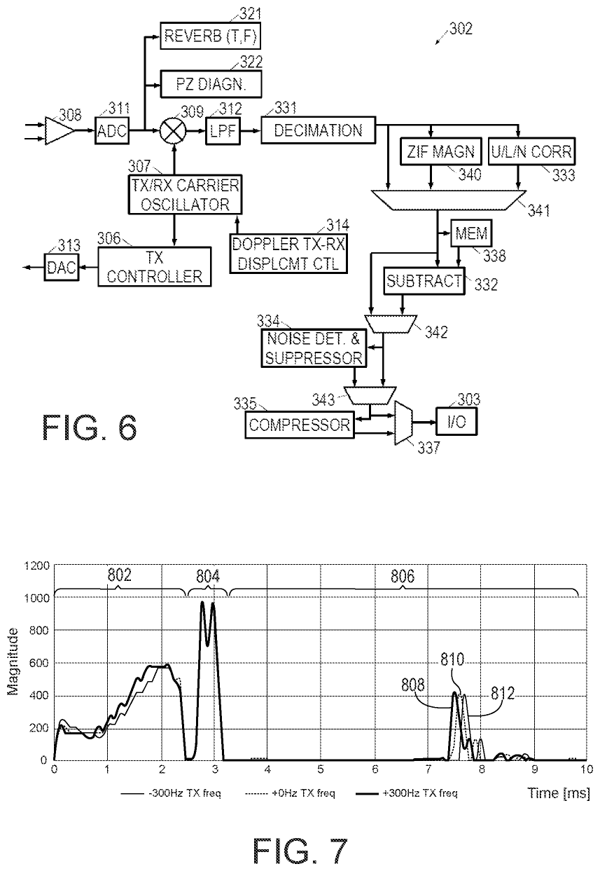

FIG. 6 is a block diagram of the controller 302 in an illustrative implementation. As described further below, the systematic interference processing may be performed entirely in the controller 302, or at least some of the processing may be performed by an ECU or host processor, which receives certain data via the communications bus as previous described with reference to FIGS. 2 and 3. For the sake of simplicity, FIG. 6 does not show all features of the controller 302, such as for instance the power electronics section.

As discussed above with reference to FIG. 3, the controller 302 includes both a receiver and a transmitter as well as a processing circuit coupled to the receiver for conversion of a received response into output data. The processing circuit may be implemented as programmable modules or application specific circuitry in a digital signal processor (DSP).

The transmitter comprises an ultrasonic carrier oscillator 307, a transmitter controller 306 and a digital to analog converter (DAC) 313. The oscillator 307 may provide, e.g., a nominal carrier frequency of 50 kHz. The TX controller 306 may derive digital burst signals from the carrier signal, in some implementations providing linear frequency modulated chirps lasting about 2.5 ms during which the frequency is swept upward from 7 kHz below the carrier frequency to 1 kHz below the carrier frequency (lower channel) or from 1 kHz above the carrier frequency to 7 kHz above the carrier frequency (upper channel). A down chirp can be employed in place of one or both of the up chirps. Depending on the system configuration, the TX controller 306 may operate solely in one channel, or may alternate or otherwise employ both upper and lower channels. DAC 313 converts the digital acoustic bursts into an analog drive signal for the acoustic transducer.

Additionally, the illustrative implementation includes a frequency displacement control unit 314 (labeled “Doppler TX-RX displacement control” due to the similarity between the Doppler effect and the effects of the frequency displacement). The frequency displacement control unit 314 is configured to apply frequency displacements to the transmit carrier frequency generated by the oscillator 307. (The reference frequency that the oscillator 307 generates for mixer 309 is preferably left constant.) Such frequency displacements are for instance in the range of 200-2000 Hz, preferably 300-1200 Hz, such as 600-1000 Hz, or 800 Hz. As described further below, the displacements of the transmit carrier frequency (with the reference frequency kept constant) cause corresponding Doppler-like frequency shifts in the echoes of the acoustic bursts. When a unique sequence of frequency displacements is applied to the transmit carrier frequency, the pattern of frequency displacements in the echoes enables true echoes to be distinguished from false echoes.

After each acoustic burst, the controller 302 receives an input signal representing the response of acoustic transducer PZ (FIG. 3) optionally amplified by a front-end amplifier 308. An analog to digital converter (ADC) 311 digitizes the input signal at a relatively high sampling rate, e.g., 400 kHz. A diagnostic block 322, alone or in combination with a reverberation monitor block 321, analyzes the digitized response signal to detect and diagnose any transducer fault conditions. Some fault conditions may be indicated by, e.g., an excessively short reverberation periods (which may be due to a disconnected or defective transducer, suppressed vibration, or the like), while others may be indicated by an excessively long reverberation period (defective mounting, inadequate clamping resistance, or the like). The diagnostic block 322 may detect and classify multiple such transducer fault conditions, storing the appropriate fault codes in internal registers, from whence they may be communicated to the ECU. Reverberation monitor block 321 detects and signals the end of the transducer reverberation period, optionally initiating the signal processing for echo detection.

The digitized response is subsequently down-converted in digital I/O mixer 309. Digital I/O mixer 309 shifts the input signal to sum and difference frequencies, in which the difference frequency is near baseband (zero frequency). I/O digital mixer 309 outputs both an in-phase component and a quadrature component of the received signal. A lowpass filter (LPF) 312 is arranged downstream of the mixer 309 to remove certain noise components (including the input signal image at the sum frequency) from the downconverted response. A decimation or “undersampling” unit 331 reduces the sampling rate of the filtered I/O signals to, e.g., about 20 kHz. This decimated signal includes both in-phase and quadrature components of the downconverted response signal, and may be referred to herein as the ZIF IQ data.

Illustrative controller 302 includes a ZIF magnitude unit 340 and a correlator 333, each of which may operate on the ZIF IQ data from decimation unit 331. The ZIF magnitude unit 340 converts the ZIF IQ data into a ZIF magnitude signal, e.g., by squaring the in-phase component signal, squaring the quadrature-phase component signal, and summing the two. The magnitude unit 340 may further determine a square root or logarithm of the summed signal.

Correlator 333 may take the form of a programmable finite impulse response filter (FIR) with complex-valued coefficients retrievable from memory. The selected coefficients provide the correlator 333 with an impulse response that preferably matches the waveform template of the acoustic bursts (up or down chirps in the upper or lower channels) and as discussed in co-owned application U.S. Ser. No. 17/156,742, filed 2021 Jan. 25 and titled “Multichannel minimum distance echo detection” (ONS04087), the impulse response may vary based on elapsed time since the end of reverberation to enhance near-range detection. (The labels U/L/N represent impulse responses for sensing upper channel bursts, lower channel bursts, and near range bursts.) The correlator's output signal includes peaks where echoes in the response signal match the correlator's impulse response. Due to the nature of chirp signals, the timing of such peaks is shifted when the echoes have a Doppler shift or frequency displacement.

Illustrative controller 302 includes a derivation processing stage, with a multiplexer 341 selecting one of the ZIF IQ data, the ZIF magnitude signal, and the correlator output signal 333, for potential derivation processing. At intervals, the selected signal may be captured in memory 338 as a baseline response. Alternatively, memory 338 may buffer the current response to be compared against the subsequent response. This response memory 338 may be a memory in the controller 302, but can alternatively be an external memory. Suitable memory types are for instance SRAM and DRAM in view of the size of the data set. For derivation processing, a subtraction unit 332 subtracts the stored response in memory 338 from the current response to remove systematic interference such as structural noise. The difference signal is supplied to a multiplexer 342, which selects the difference signal when derivation processing is desired, and selects the output of multiplexer 341 when derivation processing is not desired. Notably, the controller 302 may switch from derivation processing to non-derivation processing at a predetermined point during each measurement, which may be useful when the structural noise is expected to be present in only a small portion of the response. Thus, for example, derivation processing may be employed during period III of the measurement cycle, and not employed during period IV of the measurement cycle in FIG. 5.

Illustrative controller 302 includes a noise detector/suppressor block 334, which operates on the signal selected by multiplexer 342, applying attenuation compensation to amplify peaks representing echoes and a nonlinear function to suppress noise. Another multiplexer 343 selects between the output of block 334 and the output of multiplexer 342, enabling block 334 to be bypassed if desired.

The DSP may perform peak detection to detect echoes, relying on the timing of the peaks to determine the echo travel time and thus the distance to the obstacles. As previously mentioned, multiple approaches can be used for peak detection and determination of peak timing, such as rising edge detection, falling edge detection, and peak maximum detection, each of which may be combined with an amplitude threshold test; each of these variations is included within the scope of detecting or detected peaks. In addition to timing, the ECU may rely on measurements of the peak magnitude and persistence to determine significance. Thereto, in the implementation illustrated in FIG. 6, the output of multiplexer 343 is coupled to a magnitude detector and compressor block 335. Magnitude detector block 335 detects the peaks in the selected signal, determines the magnitude of the peaks, and calculates the time of flight (or equivalently, determines the distance) associated with each peak. An optional compression method is used to reduce the number of bits needed to represent this information. An output multiplexer 337 selects between compressed and uncompressed data for sensor interface block 303 to communicate echo measurement information to the ECU.

Note that the various multiplexers can be set to provide raw ZIF IQ data, the ZIF magnitude signal, or the correlation signal (each of which may be compressed or uncompressed) to the ECU, enabling the ECU to perform the desired processing operations. Furthermore, a further selection of ZIF IQ Data could be made, such as the in-phase components or the quadrature components. Additionally, the ZIF IQ data to be transmitted could be pre-selected, for instance only in a predefined timeframe, or during a timeframe meeting predefined criteria.

As an alternative to performing derivation processing of the ZIF IQ data, ZIF Magnitude signal, or correlation signal as shown in FIG. 6, derivation processing can be performed on the magnitude/time of flight information. For example, a baseline response may indicate the magnitude and time of flight information cause during a first measurement cycle, perhaps due to structural noise. In a subsequent measurement cycle, any corresponding peaks can be eliminated or at least reduced in proportion to the baseline response. Hence, there are several options for the signal processing. Selection of options may depend on customer requirements as well as grade and resolution of the desired output.

As mentioned previously, frequency displacement controller 314 may apply a pattern of frequency displacements to acoustic bursts in a series, each acoustic burst being frequency-shifted by a corresponding displacement value in the pattern, thereby providing a distinctive signature to true echoes in the processed response signals. For chirp signals, such frequency shifts produce a time shift in the output signal peaks of a correlator.

FIG. 7 shows three illustrative measurement cycles with corresponding frequency displacements of −300 Hz, 0 Hz, and +300 Hz. Period 802 represents the (attenuated) duration of the drive signal that generates the acoustic burst. Period 804 represents the transducer resonance period immediately following the cessation of the drive signal. Period 806 represents the echo detection period with any structural noise absent (or removed by derivation processing). At the correlator output, peaks 808, 810, and 812 correspond to the echoes received with the −300 Hz, 0 Hz, and +300 Hz frequency displacements, demonstrating a time shift of about 14 ms between peaks, corresponding to an apparent distance shift of about 2.4 cm. Frequency displacements of 800 Hz would correspond to apparent distance shifts of roughly 6 to 7 cm. Other frequency displacements could be used similarly.

Recognizing that the frequency displacement corresponds to a time shift of a reflected signal in a time-of-flight measurement, which in turn represents a shift in the measured distance, a pattern of applied frequency shifts provides a corresponding pattern in the shifts (or “jitter”) of measured distance. The pattern will be different for a fake echo than for a real echo. Particularly, for a real echo, the shift in measured distance corresponds to each frequency displacement. When each subsequent driving signal (i.e. pulse) is given a different frequency displacement and neither the monitoring system nor the obstacle moves, the measured distance would vary per pulse corresponding to the applied frequency pulse. However, a fake echo originating from another ultrasonic system will not include the specific frequency displacement pattern and can thus be recognized.

This principle will be elucidated with reference to FIG. 4. Therein the obstacle monitoring system is present in Our Car. In an example, the transmitter thereof applies following TX frequency displacement sequence: 0 Hz (0 cm), 0 Hz (0 cm), +800 Hz (+6 cm), −800 Hz (−6 cm), 0 Hz (0 cm), +800 Hz (+6 cm). Thus, in this example, the series of acoustic burst driving signals includes at least six consecutive driving signals. The frequency displacement in this example is either 0 Hz or +800 Hz or −800 Hz. When measuring a distance D0 of the real echo from the obstacle, the measured sequence will be D0, D0, D0+6 cm, D0−6 cm, D0, D0+6 cm. This measured distance sequence can be corrected for the applied frequency displacement, resulting in D0, D0, D0, D0, D0, D0. Hence, the distance does not change and the echo will be classified as a real echo.

In this example, it is assumed that the Other Car also transmits acoustic bursts that are received by the obstacle monitoring system of Our Car, either directly or after being reflected by the obstacle. For the purposes of this example, the observed distance associated with these acoustic bursts is D1. If the Other Car transmits the acoustic bursts without a pattern of frequency displacements, Our Car observes the associated distances to be D1, D1, D1, D1, D1, D1. After applying the correction for the frequency displacements used by the transmitter in Our Car, the set of measurements becomes D1, D1, D1−6 cm, D1+6 cm, D1, D1−6 cm. It is apparent that the compensated distance is not sufficiently constant, enabling Our Car to disregard the measurements as being due to a fake echo.

The same result will apply when the Other Car transmits acoustic bursts with a different pattern of frequency displacements in consecutive pulses. Effectively, there is a large variety of feasible patterns, so the chance that the applied patterns of frequency displacements is identical is very low, and if desired may be lowered even further by using a longer signature pattern. Possible variations of the pattern include the length of a pattern (6 in the example), the applied frequency displacement (0, ±800 Hz in the example), the number of different displacements per pattern, and the permutation of the order in which displacements are applied. The applied frequency displacement pattern may be cyclic, randomized, or both (a cyclic pattern of randomly chosen displacements).

In one implementation, the applied frequency displacement pattern is random, and is for instance generated during the sensor power-up. Noise monitoring (period I of FIG. 5) may occur at maximum gain setting. The least significant bits (LSB) of echo magnitude measurements during a given noise monitoring period may be used as random numbers for generating a cyclic signature pattern of frequency displacements. The frequency displacements may be stored in a look-up table (LUT) and the sampled LSBs used to address the LUT, thereby identifying the frequency displacements to be used in the pattern. The number of noise magnitude monitoring samples used herein will define the length of random TX/RX Doppler displacement sequence. This random signature generation process may be repeated intermittently or each time the sensor is powered-on.

Note that the frequency displacements may vary due to the Doppler effect if Our Car or the Other Car are moving. This will change the measured time shifts, but the shift due to the Doppler effect is expected to be relatively constant and relatively small compared to the 800 Hz displacement contemplated above, still enabling real echoes to be distinguished from fake echoes.

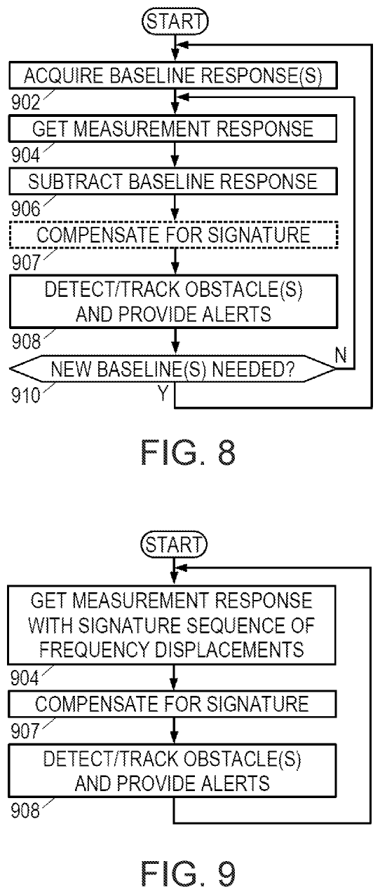

FIG. 8 is a flow diagram of an illustrative sensing method that includes derivation processing and use of the frequency displacement signature pattern. It begins in block 902 with the sensor controller 302 sending an acoustic burst and acquiring a measurement response to be stored and used as a baseline. In some implementations, a separate baseline response is acquired for each frequency displacement (e.g., −800 Hz, 0 Hz, and +800 Hz). In block 904, the sensor controller optionally begins using the frequency displacement signature in a cyclic fashion, sending an acoustic burst with the frequency displacement for the current spot in the signature sequence and acquiring a measurement response. In block 906, the sensor controller subtracts the baseline response (or in some implementations, subtracting that portion of the baseline response representing structural noise), and filters the difference signal to obtain correlation peaks. In block 907, the sensor controller compensates for the frequency displacement of the current spot in the signature sequence, e.g., by shifting the peak location by the time shift expected for that frequency displacement.

In block 908, the sensor controller (or ECU) detects obstacles by comparing correlation peaks in the sequence of responses to identify those peaks that remain relatively stationary or shift in a fashion indicating a relatively linear motion. Peaks that exhibit excessive jitter are suppressed as false echoes. Obstacles that are too close or moving too fast may cause the sensor controller (or ECU) to alert the driver.

In block 910, the sensor controller determines whether a new baseline is needed. This determination may be made if too much time has passed since the previous baseline measurement, or if another triggering event occurs (such as trimming or retuning of the oscillator generating the transmit carrier frequency). If a new baseline is needed, the process returns to block 902. Otherwise the next measurement response is acquired starting with block 904.

FIG. 9 is a flow diagram of an illustrative sensing method that omits derivation processing, but employs the previously-described signature sequence of frequency displacements. The method is a loop of the previously-described operations represented by blocks 904, 907, and 908.

Though the operations shown and described above are treated as being sequential for explanatory purposes, in practice the process may be carried out by multiple integrated circuit components operating concurrently and perhaps even speculatively to enable out-of-order operations. The sequential discussion is not meant to be limiting. Further, the foregoing description has presumed the use of an I/O line bus, but other bus implementations including LIN, CAN and DSI3 are contemplated. These and numerous other modifications, equivalents, and alternatives, will become apparent to those skilled in the art once the above disclosure is fully appreciated. It is intended that the following claims be interpreted to embrace all such modifications, equivalents, and alternatives where applicable.

According to one implementation, a controller for an acoustic transducer is provided, the controller comprising a transmitter to drive the acoustic transducer by means of a driving signal to generate acoustic bursts, said driving signal having a center frequency and being modulated according to a predefined pattern. The transmitter is configured to generate a series of consecutive driving signals, wherein a first driving signal of said series is provided at a first center frequency and a consecutive, second driving signal of said series is provided at a second center frequency that is displaced relative to the first center frequency according to a predefined frequency displacement. The controller further comprises a receiver to sense a response of the acoustic transducer to echoes of each burst. The controller further comprises a processing circuit coupled to the transmitter and to the receiver, the processing circuit operable to convert said received response into output data representative of said modulated driving signal to said response.

According to a further implementation, said frequency displacement is a Doppler shift. For instance, said frequency displacement is in the range of 200-2000 Hz. Preferably, the frequency displacement is in the range of 300-1200 Hz, for instance 600-1000 Hz, such as 800 Hz.

According to a further implementation, which may be combined with any of the implementation of the preceding two paragraphs, the transmitter is configured to apply cyclic random frequency displacements within said series of consecutive driving signals.

According to a further implementation, which may be combined with any of the implementations of the preceding three paragraphs, said driving signals of said series are chirp-modulated driving signals. Preferably, said series of consecutive driving signals has a duration of at least 1 millisecond (ms). The chirp-modulated driving signal is for instance a so-called sideband chirp, having a center frequency that is lower or higher than that of an amplitude-modulated (AM) signal. A chirp is a transmit pulse that changes frequency during transmission. The response of a chirp may be compressed in a correlator without introducing much or any correlation noise. The chirp may be an up-chirp (chirp with an increasing frequency) and down-chirp (chirp with a decreasing frequency). In one further implementation, the down-chirp has an inverted slope when compared with the up-chirp. In another further implementation, the down-chirp has a different center frequency when compared to the up-chirp.

According to a further implementation, which may be combined with any of the implementations of the preceding four paragraphs, said processing circuit is configured to apply derivation based apply echo detection processing to said response. For instance, said processing circuit comprises a correlator for correlation of a received signal and a magnitude detector for detection a magnitude of said correlated signal.

According to a further implementation, which may be combined with any of the implementations of the preceding six paragraphs, said output data comprise Zero Intermediate Frequency IQ (ZIF-IQ)-data, and correlation magnitude data, wherein said controller is further provided with a bus interface for transmission of said output data to a microcontroller. For instance, said processing circuit comprises a ZIF-IQ compressor for compressing said ZIF-IQ data and a multiplexer for multiplexing said compressed ZIF-IQ data with the correlation magnitude data in compressed form.

According to a further implementation, which may be combined with any of the implementations of the preceding seven paragraphs, the controller further comprises a memory for storing a response, and wherein said processing circuit comprises a subtraction unit for subtracting a received response from a stored response.

1. A controller for an acoustic transducer, the controller comprising:
a transmitter configured to drive the acoustic transducer to generate acoustic bursts;
a receiver coupled to the acoustic transducer and configured to sense a respective response for each of the acoustic bursts; and
a processing circuit configured to derive output data from the responses,
wherein each of the acoustic bursts has a respective frequency displacement from a sequence of frequency displacements associated with the acoustic transducer.

2. The controller of claim 1, wherein the controller comprises a frequency displacement control unit that is configured to apply the frequency displacements to a transmit carrier frequency.

3. The controller of claim 2, wherein the frequency displacements are in a range of 200-2000 Hz.

4. The controller of claim 3, wherein the frequency displacements are in a range of 300-1200 Hz.

5. The controller of claim 1, wherein the processing circuit is further configured to suppress any peaks in the output data not conforming to the sequence of frequency displacements.

6. The controller of claim 1, wherein the transmitter is configured to generate the acoustic bursts by generating a series of consecutive driving signals.

7. The controller of claim 6,
wherein a first of the acoustic bursts is provided at a first center frequency, and
wherein a second of the acoustic bursts is consecutive with the first of the acoustic bursts and is provided at a second center frequency that is displaced relative to the first center frequency according to the sequence of frequency displacements.

8. The controller of claim 1, wherein the sequence of frequency displacements is unique to the acoustic transducer.

9. An obstacle-detection method comprising:
providing a first acoustic burst to a transducer at a first center frequency; and
providing, to the transducer, a second acoustic burst at a second center frequency that is displaced relative to the first center frequency according to a frequency displacement pattern,
wherein the second acoustic burst is consecutive to the first acoustic burst.

10. The method of claim 9, further comprising receiving first and second responses to the first and second acoustic bursts, respectively.

11. The method of claim 10, further comprising:
converting the responses into first zero intermediate frequency (ZIF) IQ data corresponding to the first acoustic burst and second ZIF IQ data corresponding to the second acoustic burst;
applying derivation-based processing to the first and second ZIF IQ data, to calculate a derivative magnitude,
wherein applying derivation-based processing comprises performing subtraction between the first and second ZIF IQ data; and
identifying a distance to an object based on the calculated derivative magnitude.

12. A controller for an acoustic transducer, the controller comprising:
a transmitter configured to transmit a plurality of first ultrasonic signals from a first vehicle according to a frequency displacement pattern;
a receiver coupled to the acoustic transducer and configured to sense a plurality of reflected ultrasonic signals; and
a processing circuit configured to determine whether the reflected ultrasonic signals are reflections of the first ultrasonic signals or reflections of a plurality of second ultrasonic signals from a second vehicle, based on whether the reflected ultrasonic signals correspond to the frequency displacement pattern.

13. The controller of claim 12, wherein the first ultrasonic signals comprise chirps.

14. The controller of claim 12, wherein the frequency displacement pattern corresponds to time shifts of the reflections of the first ultrasonic signals.

15. The controller of claim 12, wherein the processing circuit is configured to determine whether the reflected ultrasonic signals correspond to the frequency displacement pattern by determining whether measured distances shift in correspondence with the frequency displacement pattern.

16. A method comprising:
transmitting a plurality of first ultrasonic signals from a first vehicle according to a frequency displacement pattern;
detecting, by an obstacle monitoring system of the first vehicle, a plurality of reflected ultrasonic signals; and
determining whether the reflected ultrasonic signals are reflections of the first ultrasonic signals or reflections of a plurality of second ultrasonic signals from a second vehicle, based on whether the reflected ultrasonic signals correspond to the frequency displacement pattern.

17. The method of claim 16, wherein transmitting the first ultrasonic signals according to the frequency displacement pattern comprises applying, by the obstacle monitoring system, a pattern of frequency shifts.

18. The method of claim 16, wherein determining whether the reflected ultrasonic signals correspond to the frequency displacement pattern comprises determining whether measured distances shift in correspondence with the frequency displacement pattern.

19. The method of claim 16, wherein the reflections of the first ultrasonic signals are reflections from an obstacle.

20. The method of claim 19, wherein the reflections of the second ultrasonic signals are reflections from the obstacle.
